(19) United States
(12) Patent Application Publication
(10) Pub. No.: US 2005/0154671 A1
(43) Pub. Date: Jul. 14, 2005

(54) Systems and methods for mitigating identity theft associated with use of credit and debit cards

(75) Inventors: Christopher Doan, Austin, TX (US); Liliana Orozco, Del Valley, TX (US)

Correspondence Address: Barry S. Newberger, P.O. Box 50784, 400 North Ervay Street, Dallas, TX, 75201, US

(73) Assignee: International Business Machines Corporation, Armonk, NY (US)

(21) Appl. No.: 10/753,854

(22) Filed: Jan. 8, 2004

(51) Int. Cl. G06F 17/60

(52) U.S. Cl. 705/39; 705/64

(57) ABSTRACT

The methods and systems of the present invention addresses the problem of identity theft associated with the use of a credit/debit card. A security code having a predetermined expiration, or equivalently lifetime, is generated. The cardholder is informed that his/her current security code is ready for downloading by sending a “security code ready” message to the cardholder. On receiving a transaction from the cardholder with an included a second security code, the security code is verified against the current, that is, the presently unexpired, security code.

### TECHNICAL FIELD

The present invention relates to data processing systems, and in particular to data processing systems for reducing the opportunity for identity theft arising from the use of credit cards by associating a daily security code with the account number during a credit card transaction.

### BACKGROUND INFORMATION

Modern economies rely extensively on noncash transactions between business enterprises and consumers. In particular, personal credit cards have become ubiquitous. This, in turn, offers a unscrupulous individuals the opportunity to “steal” the identity of the credit card holder, and incur charges against the cardholder's account for their own benefit. For example, dishonest employees of the business may keep the impression of the card number and patron signature. Additionally, the card itself may be stolen which gives the thief the account number, cardholder name and a copy of the cardholder's signature.

Thus, there is a need in the art for systems and methods for reducing the opportunities for identity theft. In particular, there is a need for mechanisms to reduce the opportunity for identity theft associated with the use of credit or debit cards by consumers.

### SUMMARY

The aforementioned needs are addressed by the present invention. Accordingly, there is provided a method for mitigating identity theft. A security code having a predetermined expiration, or equivalently lifetime, is generated. The cardholder is informed that his/her current security code is ready for downloading by sending a “security code ready” message to the cardholder. On receiving a transaction from the cardholder with an included a second security code, the security code is verified against the current, that is, the presently unexpired, security code.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following description taken in conjunction with the accompanying drawings, in which:

FIG. 1 illustrates, in flow chart form, a methodology for securing a credit or debit card transaction in accordance with an embodiment of the present invention;

FIG. 2 illustrates, in flow chart form, a methodology for transaction authentication in accordance with an embodiment of the present invention;

FIG. 3 illustrates, in flow chart form, a methodology for requesting a security code in accordance with an embodiment of the present invention;

FIG. 4 illustrates, in flow chart form, a methodology for establishing a secure credit card transaction account which may be used in conjunction with the present inventive principles; and

FIG. 5 illustrates, in block diagram form, a data processing system which may be used in conjunction with the methodologies of the present invention.

### DETAILED DESCRIPTION

In the following description, numerous specific details are set forth to provide a thorough understanding of the present invention. For example, particular protocols, or encryption techniques may be referred to so as to illustrate the present inventive principles. However, it would be recognized by those of ordinary skill in the art that the present invention may be practiced without such specific details, and in other instances, well-known circuits have been shown in block diagram form so as to not obscure the present invention in unnecessary detail. Refer now to the drawings wherein depicted elements are not necessarily shown to scale and wherein like or similar elements are designated by the same reference numeral through the several views.

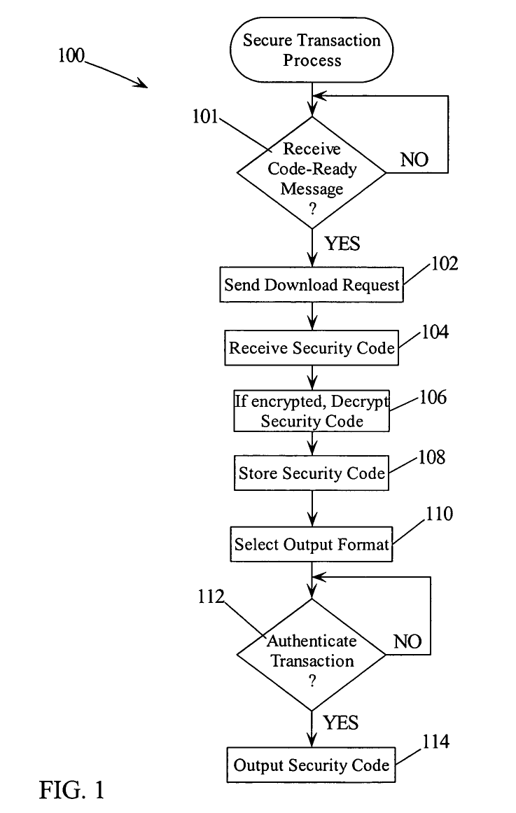

Referring to FIG. 1, there is illustrated therein, in flow chart form, a process 100 for securing a credit card (or equally, a debit card) transaction in accordance with an embodiment of the present invention. Process 100 may be performed on the cardholder's personal data communication device. These may include a cell phone equipped with digital messaging, a portable digital email device, such as a Blackberry™ device manufactured by Aether Systems, Inc., Owings Mills, Md., a personal digital assistant equipped with a link to the Internet such as a IEEE 802.11 wireless link (commonly referred to as “WiFi”) or similarly equipped personal computer such as a conventional laptop or notebook computer.

In step 101, it is determined if a code-ready message has been received. (As described below, upon expiration of a security code, the issuer may generate a new security code.) If the new security code-ready message has been received, process 100 proceeds to step 102.

In step 102, a security code download request is transmitted to the credit/debit card issuer. Typically, the request may include the cardholder's name and a preselected password. (Methodologies for transmitting the security code in response to the request and setting up the secure transaction account will be described further hereinbelow.) Because the message typically will include a password to for authenticating the cardholder to the process for returning the security code, the request may be transmitted using a secure communication medium. For example, if the request is transmitted via email, the request may be encapsulated as a S/MIME-encrypted message. Alternatively, a Secure Sockets Layer (SSL) session may be used to connect the email client on the cardholder's personal data processing device to the email server. Secure Sockets Layer version 3 (SSLv3/TLS), for example, may be used with the standardized email protocols such as SMTP (Simple Mail Transfer Protocol), IMAP ( ) and Post Office Protocol (POP). SSL may also be used in conjunction with a Web client for sending the request via the Internet in a HTTP (Hypertext Transfer Protocol) request. Additionally, digital messages may be securely communicated in a cell phone link by encrypting the message. In an embodiment using a symmetric-key encryption scheme, the key may be generated at the beginning of the day by the cellular device. Alternatively, in an asymmetric-key scheme, the decryption key may be part of a pair of public/private keys whereby the message is encoded by the sending party using the receiving party's public key and the receiving cellular device decrypts the incoming message using the private key before displaying it to the user.

In step 104, the security code is received. The code may be encrypted to prevent its interception by unauthorized persons.

In step 106, if the security code is encrypted, the encrypted security code is decrypted. One mechanism for encrypting the security code may be symmetric-key encryption in which the same encryption key is used to decrypt the ciphertext as was used to encrypt the plaintext to generate the ciphertext. The encryption key may be distributed to the cardholder on a storage medium such as a CD-ROM when the cardholder opens his or her account. In step 108, the decrypted security code is stored.

The security code may be in the form of an ASCII character string, for example. Depending on the type of the cardholder's personal data processing device, it may be desirable to output the security code in different formats. Thus, if the device is a handheld portable device such as a cell phone or PDA which may readily be available at a point of sale, it may be preferred to output the security code in a format that is machine readable, such as by a bar code reader. Alternatively, if such a reader is unavailable, or the cardholder's device is not readily available at the point of sale, displaying the security code as an ASCII string may be preferred. Thus, an output format may be selected in step 110. Such a selection may be made via a configuration or preferences panel, although any similar mechanism that would be understood by persons of ordinary skill in the art may be used in alternative embodiments of the present invention.

When the user chooses to authenticate a transaction, step 112, the security code is output. The code may then be scanned if in barcode format, for example, or entered “by hand” on a keypad or other manual input device connected to the merchant's credit/debit card reader or other credit card data input device. In step 114, the security code is output in the selected format.

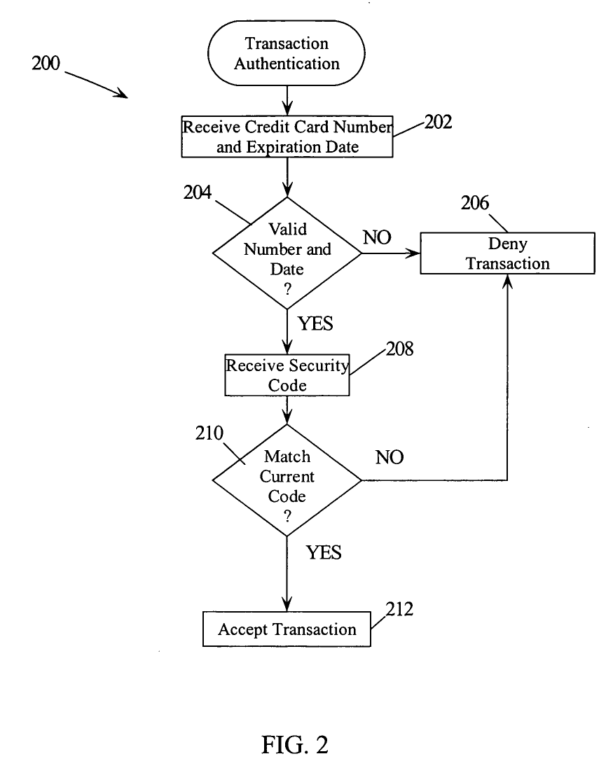

Referring now to FIG. 2, there is illustrated a methodology 200 for authenticating a transaction in accordance an embodiment of the present invention which may be used in conjunction with the methodology of FIG. 1. Process 200 may be performed by or on behalf of the card issuer.

In step 202, the credit/debit card number and expiration date are received from the merchant's card reader or other data input device. Note that, in general, the communications channel between the merchant's data input device and the card issuer, is different than the communication channel between the card holder and the card issuer. In step 204, the validity of the credit card number and expiration date are determined. These may be compared against the issuer's database. If either the card number or expiration date are incorrect, the transaction is denied in step 206. If the card number and expiration date are valid, process 200 proceeds to step 208.

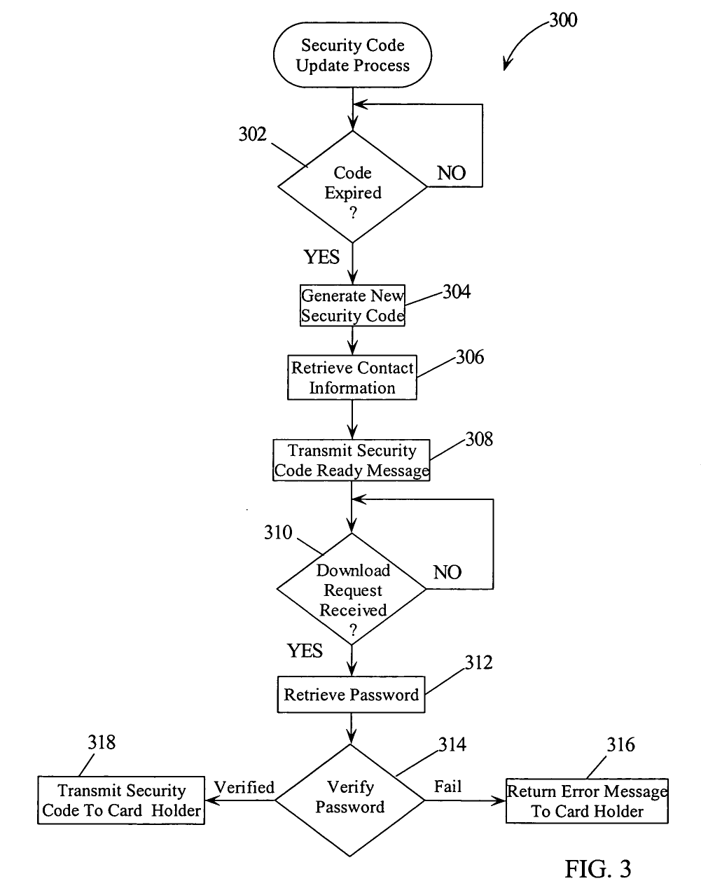

In step 208, the security code is received. The number received is matched against the current code in step 210. In accordance with the present inventive principles, a security code may have a limited validity period. A security code may expire after a predetermined period of time after it is issued to the cardholder. For example, a security code may be valid for a day, that is a twenty-four hour period, after which a cardholder would request a new security code by sending a request as described hereinbelow in conjunction with FIG. 3. If the received security code does not match the currently valid code, the transaction is denied, step 206. Conversely, if the security code is the current code, the transaction is accepted, step 212.

FIG. 3 illustrates a process 300 for processing a request for a security code in accordance with an embodiment of the present invention. In step 302, it is determined if the current security code is expired. As previously noted, a security code may expire after a predetermined period of time after it is issued to the cardholder. For example, a security code may be valid for a day, that is a twenty-four hour period, after which a new security code may be needed to authenticate a transaction.

In step 304, the a new security code is generated. The code may be generated, for example, using a random number generator, which may be used to generate a random sequence of alphanumeric ASCII characters.

In step 306, the cardholder's account registry is accessed, and the cardholder's contact information retrieved. Contact information may be for example, a cell phone number or an email address. In step 308, a security code ready message is sent to the cardholder using the contact information retrieved in step 306. Recall that, in general, the communication channel over which the message is sent is different than the channel between the merchant card issuer.

Process 300 then waits for a request for the security code from the cardholder, step 310. A request includes a cardholder password registered with the contact information, as discussed below. If the request is received, in step 312, the password is retrieved from the cardholder registry, and in step 314 the received password is verified against the registered password. If the verification fails, an error message is returned to the user by the same communication method by which the cardholder sent the communication request, step 316. For example, if the request was an HTTP request, a Web page displaying an error message may be returned to the cardholder. Likewise a digital cell message may be returned to the cardholder indicating that the request to download the security code failed.

Conversely, if the password verifies, the security code is transmitted to the cardholder in step 318. As previously described, the security code may be received in encrypted form and decoded before being displayed to the user. In this way, the data transactions are secured, and data integrity as well as privacy maintained.

In an alternative embodiment of methodology 300, step 308 may be omitted, and the new security code communicated to the cardholder in response to a request received, step 310. For example, the cardholder may be reminded that he or she needs to request a new security code if a transaction fails because the security code associated with that transaction has expired.

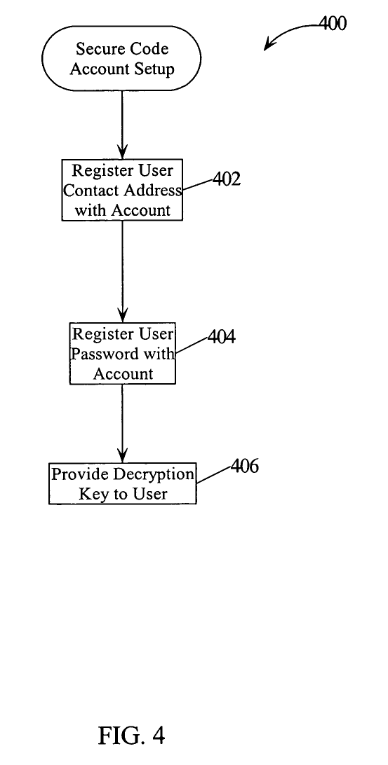

In FIG. 4, a methodology 400 for setting up a cardholder security account is illustrated. In step 402, cardholder contact information is registered in an account registry for the cardholder. Contact information may include a cell phone number for the cardholder, or an email address, for example. The contact information may be used to send the security code ready message to the cardholder, as previously discussed in conjunction with FIG. 3. In step 404 a password is registered. This password is used to verify the cardholder's request to download the security code. In step 406 a decryption key that may be used to decrypt an encrypted security code may be provided via a secure communication channel to the cardholder. For example, the key may be written to a machine readable file on a physical storage medium such as a CD-ROM that may be sent to the cardholder. If the security code account is set up when the cardholder's credit/debit card account is established, the encryption code may be sent to the user along with the credit/debit card.

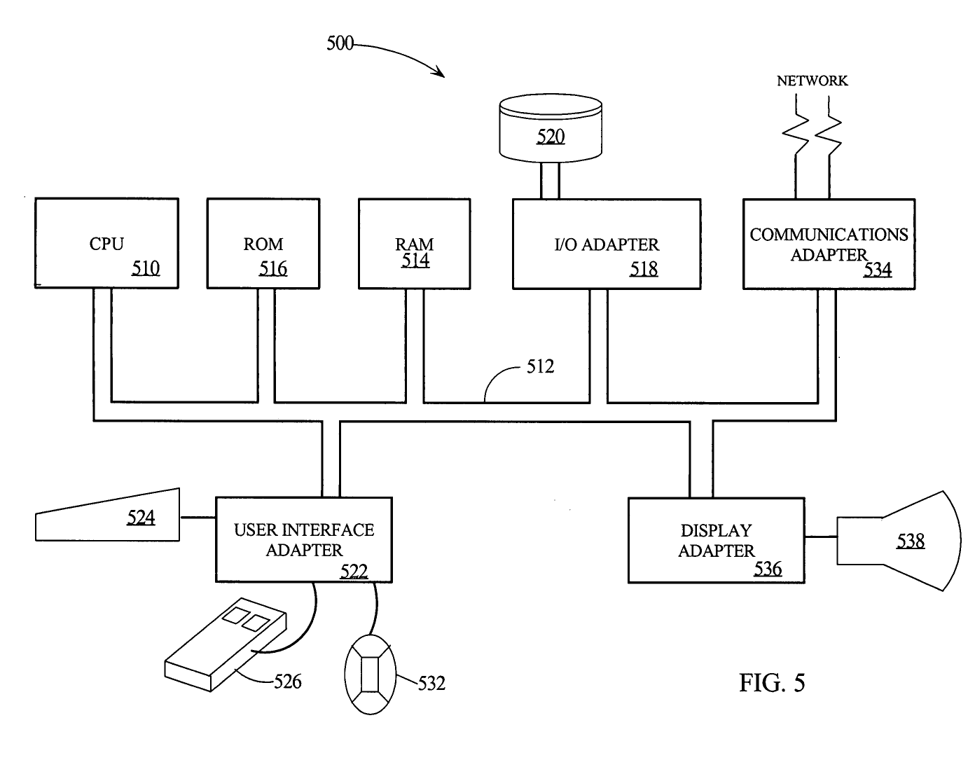

FIG. 5 illustrates an exemplary hardware configuration of data processing system 500 in accordance with the subject invention. The system in conjunction with the methodology illustrated in FIGS. 1 and 3 may be used to provide credit/debit card transactions shielded from identity theft in accordance with the present inventive principles. Similarly, system 500 may be used in conjunction with the methodology illustrated in FIG. 2 authorize a credit/debit card transaction in accordance with the present inventive principles. Data processing system 500 includes central processing unit (CPU) 510, such as a conventional microprocessor, and a number of other units interconnected via system bus 512. Data processing system 500 also includes random access memory (RAM) 514, read only memory (ROM) 516 and input/output (I/O) adapter 518 for connecting peripheral devices such as disk units 520 to bus 512, user interface adapter 522 for connecting keyboard 524, mouse 526, trackball 532 and/or other user interface devices such as a touch screen device (not shown) to bus 512. System 500 also includes communication adapter 534 for connecting data processing system 500 to a data processing network, enabling the system to communicate with other systems, and display adapter 536 for connecting bus 512 to display device 538. CPU 510 may include other circuitry not shown herein, which will include circuitry commonly found within a microprocessor, e.g. execution units, bus interface units, arithmetic logic units, etc. CPU 510 may also reside on a single integrated circuit.

Preferred implementations of the invention include implementations as a computer system programmed to execute the method or methods described herein, and as a computer program product. According to the computer system implementation, sets of instructions for executing the method or methods are resident in the random access memory 514 of one or more computer systems configured generally as described above. These sets of instructions, in conjunction with system components that execute them may be used to provide credit/debit card transactions shielded from identity theft as described hereinabove. Until required by the computer system, the set of instructions may be stored as a computer program product in another computer memory, for example, in disk drive 520 (which may include a removable memory such as an optical disk or floppy disk for eventual use in the disk drive 520). Further, the computer program product can also be stored at another computer and transmitted to the users work station by a network or by an external network such as the Internet. One skilled in the art would appreciate that the physical storage of the sets of instructions physically changes the medium upon which is the stored so that the medium carries computer readable information. The change may be electrical, magnetic, chemical, biological, or some other physical change. While it is convenient to describe the invention in terms of instructions, symbols, characters, or the like, the reader should remember that all of these in similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

Although the present invention and its advantages have been described in detail, it should be understood that various changes, substitutions and alterations can be made herein without departing from the spirit and scope of the invention as defined by the appended claims.

1. A method for mitigating identity theft comprising:
generating a first security code, said first security code having a predetermined expiration time;
transmitting said first security code to a cardholder;
receiving a card transaction from said cardholder, said transaction including a second security code; and
verifying said second security code is equal to said first security code.

2. The method of claim 1 further comprising receiving a request to download said first security code.

3. The method of claim 2 further comprising verifying a first password included in said request against a second password registered for said cardholder.

4. The method of claim 1 further comprising sending a message to a cardholder indicating said first security code is ready for downloading by said cardholder.

5. The method of claim 1 further comprising if said verifying step fails, denying said transaction.

6. The method of claim 1 further comprising:
registering a password in a cardholder account registry for downloading said first security code in response to said message to said cardholder indicating said first security code is ready, and
registering cardholder contact information in said cardholder account registry, said contact information for sending said message to said cardholder.

7. The method of claim 6 wherein said contact information include a cell telephone number for said cardholder.

8. A computer program product embodied in a computer readable medium, the program product including programming instructions for performing the operations of:
generating a first security code, said first security code having a predetermined expiration time;
transmitting said first security code to a cardholder;
receiving a card transaction from said cardholder, said transaction including a second security code; and
verifying said second security code is equal to said first security code.

9. The computer program product of claim 8 further comprising programming instructions for performing the operations of receiving a request to download said first security code.

10. The computer program product of claim 9 further comprising programming instructions for performing the operations of verifying a first password included in said request against a second password registered for said cardholder.

11. The computer program product of claim 8 further comprising programming instructions for performing the operations of sending a message to a cardholder indicating said first security code is ready for downloading by said cardholder.

12. The computer program product of claim 8 further comprising programming instructions for performing the operations of, if said verifying step fails, denying said transaction.

13. The computer program product of claim 8 further comprising programming instructions for performing the operations of:
registering a password in a cardholder account registry for downloading said first security code in response to said message to said cardholder indicating said first security code is ready; and
registering cardholder contact information in said cardholder account registry, said contact information for sending said message to said cardholder.

14. The computer program product of claim 13 wherein said contact information include a cell telephone number for said cardholder.

15. A data processing system for mitigating identity theft comprising:
circuitry operable for generating a first security code, said first security code having a predetermined expiration time;
circuitry operable for transmitting said first security code to a cardholder;
circuitry operable for receiving a card transaction from said cardholder, said transaction including a second security code; and
circuitry operable for verifying said second security code is equal to said first security code.

16. The data processing system of claim 15 further comprising circuitry operable for receiving a request to download said first security code.

17. The data processing system of claim 16 further comprising circuitry operable for verifying a first password included in said request against a second password registered for said cardholder.

18. The data processing system of claim 17 further comprising circuitry operable for, sending a message to a cardholder indicating said first security code is ready for downloading by said cardholder.

19. The data processing system of claim 15 further comprising circuitry operable for, if said verifying step fails, denying said transaction.

20. The data processing system of claim 15 further comprising:
circuitry operable for registering a password in a cardholder account registry for downloading said first security code in response to said message to said cardholder indicating said first security code is ready; and
circuitry operable for registering cardholder contact information in said cardholder account registry, said contact information for sending said message to said cardholder.
